(19) United States
(12) Patent Application Publication
(10) Pub. No.: US 2026/0156729 A1
(43) Pub. Date: Jun. 4, 2026

(54) LED Luminaire with Reduced Visible Flicker

(71) Applicant: Elemental LED, Inc., Reno, NV (US)

(72) Inventors: William H. Avery, JR., Reno, NV (US); Travis Irons, Reno, NV (US)

(21) Appl. No.: 19/399,562

(22) Filed: Nov. 24, 2025

Related U.S. Application Data
(60) Provisional application No. 63/728,017, filed on Dec. 4, 2024.

(51) Int. Cl. H05B 45/59

(52) U.S. Cl. CPC H05B 45/59

(57) ABSTRACT

A lighting circuit for solid-state lighting, such as light-emitting diodes (LEDs), is configured to produce reduced visible flicker. The lighting circuit may accept time-varying input power, such as alternating current (AC) power or rectified AC power. Within the circuit, a plurality of LED light engines are grouped in sets. Some of the sets receive unaltered input power, while other sets receive input power that has been shifted in phase. The phases of the sets of LED light engines are coordinated such that, at any time during the power cycle, at least one set of LED light engines is illuminated, and the lighting circuit as a whole produces a substantially constant luminous flux over the entire power cycle. LED light engines from different sets may be grouped or clustered together on a printed circuit board such that, in the aggregate, they do not produce the illusion of movement during illumination.

### CROSS-REFERENCE TO RELATED APPLICATIONS

This application claims priority to, and the benefit of, U.S. Provisional Patent Application No. 63/728,017, filed Dec. 4, 2024, the contents of which are incorporated by reference herein in their entirety.

### TECHNICAL FIELD

Embodiments of the invention relate to an LED luminaire with reduced visible flicker, to circuits for powering and controlling such luminaires, and to methods for reducing visible flicker in LED luminaires.

### BACKGROUND

Lighting based on light-emitting diodes (LEDs) has supplanted traditional incandescent and fluorescent lighting. LED-based lighting can often provide better quality light with less energy consumption than incandescent and fluorescent luminaires. Because LED-based luminaires can be made in a variety of forms, some of very small size, LED-based luminaires can also be placed where traditional incandescent and fluorescent fixtures cannot.

Despite many advantages, LED-based luminaires do have certain drawbacks. For one, as solid-state devices, LEDs respond quickly to changes in voltage and current. While this allows LEDs to turn on and off quickly, it also means that if the power supplied to the LEDs varies over time, the LEDs may show a visible flicker. As a practical matter, most power supplied to LED luminaires is time-varying: typical household and commercial power is supplied as time-varying alternating current (AC) power, and when AC power is converted to direct current (DC) power for LED use, the conversion is often imperfect, with the DC power still varying to some degree with time. Thus, many LED luminaires flicker in use.

Research has identified flicker in luminaires as a potential health hazard, and some jurisdictions regulate flicker, e.g., by requiring luminaires to have less than 30% light-emission amplitude variation at visible frequencies, e.g., less than 200 Hz. To that end, PCT International Publication No. WO2024/006948 discloses a high-voltage AC luminaire in which two sets of LEDs are interdigitated with one another. One of those sets of LEDs is electrically configured so as to be powered during the positive half-cycle of an AC power cycle, and the second of the two sets of LEDs is arranged to be powered during the negative half-cycle of the AC power cycle. While this arrangement does reduce flicker somewhat by ensuring, essentially, that there is always at least one set of LEDs emitting light, the result may still exhibit some visible flicker, and may not meet regulatory requirements.

### BRIEF SUMMARY

One aspect of the invention relates to a lighting circuit. The lighting circuit comprises a printed circuit board (PCB) and a plurality of sets of LED light engines disposed on the PCB. Each of the plurality of sets of LED light engines is configured to receive AC power and to emit light during a different portion of a single AC power cycle. In the lighting circuit, some of the plurality of sets of LED light engines receive phase-shifted AC power. The different portions of the AC power cycle are coordinated such that the lighting circuit has a substantially constant luminous flux throughout the single AC power cycle.

The lighting circuit may include a phase-shifting component that has an electrical reactance. The phase-shifting component receives the AC power and changes the phase of the current with respect to the voltage of the AC power. The phase-shifting component may be a capacitor or an inductor.

The plurality of sets of LED light engines may comprise a first set of LED light engines, a second set of LED light engines, a third set of LED light engines, and a fourth set of LED light engines. The first set of LED light engines is configured to receive the AC power and to be forward-biased during a positive half-cycle of the AC power cycle. The second set of LED light engines is configured to receive the AC power and to be forward-biased during a negative half-cycle of the AC power cycle. The third set of LED light engines is configured to receive the phase-shifted AC power and to be forward-biased during a positive half-cycle of the phase-shifted AC power cycle. The fourth set of LED light engines is configured to receive the phase-shifted AC power and to be forward-based during a negative half-cycle of the phase-shifted AC power cycle.

Each of the LED light engines of the third set of LED light engines may be arranged electrically in parallel with others of the third set of LED light engines. Similarly, each of the LED light engines of the fourth set of LED light engines may be arranged electrically in parallel with others of the fourth set of LED light engines.

The LED light engines of the first set of LED light engines, the second set of LED light engines, the third set of LED light engines, and the fourth set of LED light engines may be arranged on the PCB in clusters, with one of the LED light engines of each of the first set of LED light engines, the second set of LED light engines, the third set of LED light engines, and the fourth set of LED light engines in each of the clusters. Each of the clusters may be arranged such that sequential lighting of the LED light engines in each cluster will not create an illusion of movement.

Another aspect of the invention relates to a lighting circuit. The lighting circuit includes at least one phase-shifting component having an electrical reactance, and a printed circuit board (PCB). On the PCB are an AC power input line, a phase-shifted AC power input line configured to receive phase-shifted AC power from the at least one phase-shifting component, and a neutral line. A first set of LED light engines is disposed on the PCB and connected to the AC power input line and the neutral line, a second set of LED light engines is disposed on the PCB and connected to the AC power input line and the neutral line, a third set of LED light engines is disposed on the PCB and connected to the phase-shifted AC power input line and the neutral line, and a fourth set of LED light engines is disposed on the PCB and connected to the phase-shifted AC power input line and the neutral line. A first diode is connected between the AC power input line and the first set of LED light engines, with the first diode and the first set of LED light engines arranged such that the first set of LED light engines is forward-biased during a positive half-cycle of the AC power. A second diode is connected between the AC power input line and the second set of LED light engines, with the second diode and the second set of LED light engines arranged such that the second set of LED light engines is forward-biased during a negative half-cycle of the AC power. A third diode is connected between the phase-shifted AC power input line and the third set of LED light engines, with the third diode and the third set of LED light engines arranged such that the third set of LED light engines is forward-biased during a positive half-cycle of the phase-shifted AC power. A fourth diode is connected between the phase-shifted AC power input line and the fourth set of LED light engines, with the fourth diode and the fourth set of LED light engines arranged such that the fourth set of LED light engines is forward-biased during a negative half-cycle of the phase-shifted AC power.

Yet another aspect of the invention also relates to a lighting circuit. The lighting circuit comprises a printed circuit board (PCB), a cluster of LED light engines provided on the PCB, and a drive circuit. The drive circuit is adapted to receive AC power, to divide an AC power cycle of the AC power into multiple portions, and to cause at least one of the LED light engines in the cluster to illuminate during each of the multiple portions of the AC power cycle. The drive circuit maintains a substantially constant luminous flux for the cluster throughout the AC power cycle. In doing so, the drive circuit may receive phase-shifted AC power and provide that phase-shifted AC power to some of the LED light engines.

A further aspect of the invention relates to a method. The method comprises providing a cluster of LED light engines on a PCB, with the LED light engines in the cluster being physically adjacent to one another, dividing an AC power cycle into a plurality of portions, and illuminating at least one LED light engine from the cluster during each of the portions of the AC power cycle. The illuminating is performed such that the cluster has a substantially constant luminous flux throughout the AC power cycle.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the description, and in which:

FIGS. 1-1 and 1-2 are two portions of a schematic diagram of a lighting circuit for an LED-based luminaire;

FIG. 2 is a diagram of voltage-time and current-time waveforms, illustrating an AC power cycle and the current in the LEDs of the lighting circuit of FIGS. 1-1 and 1-2;

FIG. 3 is a top plan view of a strip of LED linear lighting that implements the lighting circuit of FIGS. 1-1 and 1-2;

FIGS. 4-7 are a chronological series of top plan views of a portion of the LED linear lighting of FIG. 4, illustrating one possible order or pattern in which individual LED light engines in a cluster are illuminated;

FIG. 8 is a plot of the voltage output of a pin photodiode set to observe the light output of the circuit of FIG. 1;

FIG. 9 is a filtered, amplified plot of the voltage output signal of FIG. 8; and

FIG. 10 is a power (i.e., Fourier) spectrum for the circuit of FIG. 1, based on the photodiode output of FIG. 8.

### DETAILED DESCRIPTION

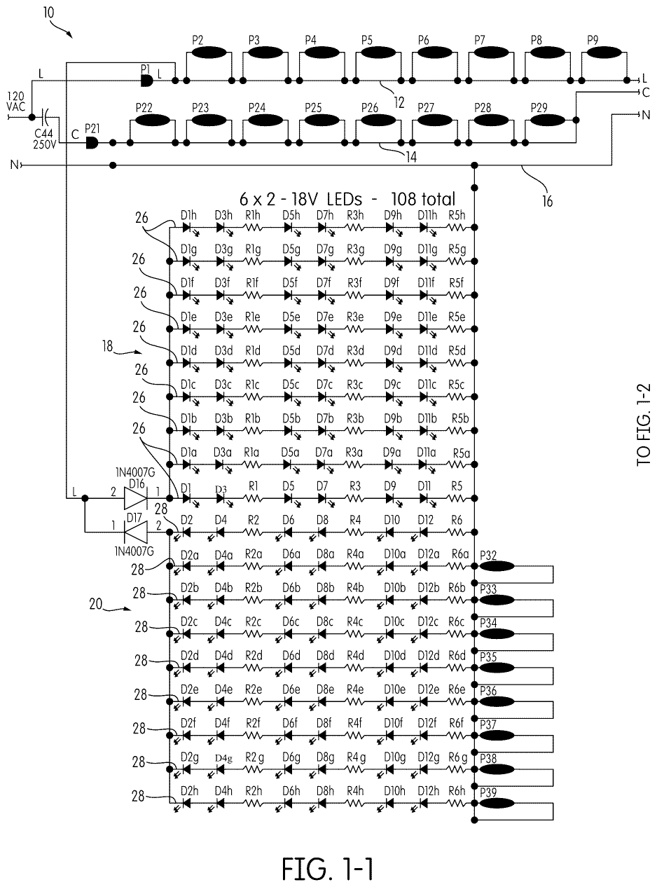

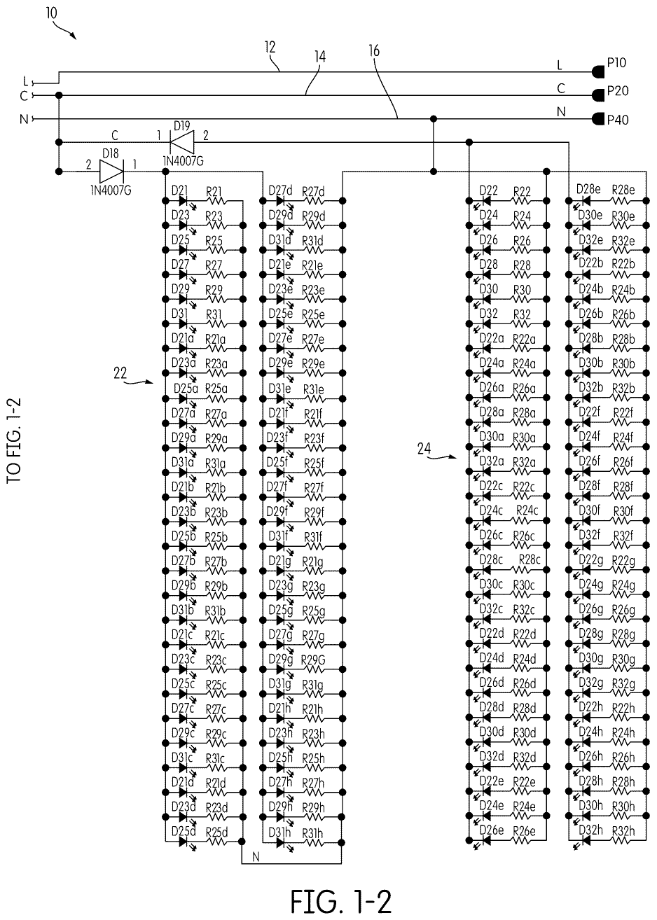

FIGS. 1-1 and 1-2 are two portions of a schematic diagram of a lighting circuit, generally indicated at 10, according to one embodiment of the invention. As will be described below in more detail, the lighting circuit 10 takes AC power as input, and has multiple sets of LED light engines, each set of LED light engines electrically arranged to light during a specific portion of the AC power cycle.

This description will assume that the AC power input to the lighting circuit 10 is 120V at 60 Hz, although other voltages and frequencies are possible. Unless otherwise indicated, AC voltages given in this description are root mean square (RMS) voltages; thus, the positive peak of a 120V AC waveform is at about 170V, and the negative peak is at about-170V. A single “power cycle,” as this description uses that term, is a voltage vs. time sinusoid that begins at 0V, rises to the positive peak voltage, descends from the positive peak voltage to the negative peak voltage, and returns to 0V. Thus, a power cycle has a positive half-cycle, during which its voltage is greater than zero, and a negative half-cycle, during which its voltage is less than zero. An AC power waveform has a phase that describes where in the power cycle the waveform is at particular points in time. Phase is described in degrees from 0° to 360°. By convention, a waveform with a phase of 0° is at 0V at the beginning of the power cycle at time zero, and rises from zero. In this description, a phase of 0° is used to describe power with unshifted voltage.

With respect to FIGS. 1-1 and 1-2, the lighting circuit 10 has an AC input line 12, a phase-shifted AC input line 14, and a shared neutral line 16. Contact pads P2-P9 are provided on the printed circuit board and connected to the AC input line 12 to connect the lighting circuit 10 to power, contact pads P22-P29 are connected to the phase-shifted AC input line 14, and contact pads P32-P39 are connected to the neutral line for the same purpose. The contact pads P2-P39 will be further explained below.

The AC input line 12 receives unaltered AC power, i.e., of 0° phase. The phase-shifted AC input line 14 receives AC power that is of substantially the same magnitude and shape as the unaltered AC power but is phase-shifted relative to the phase of the AC power. In the configuration that will be described below in more detail, the current in the phase-shifted AC input line 14 is a factor of six higher than the current in the AC input line 12, and the voltage in the phase-shifted AC input line 14 is a factor of six lower than the voltage in the AC input line 12. This results in the same average power to each LED light engine in LED light engines.

To create the phase shift, a capacitor C44 is connected between the phase-shifted AC input line 14 and the power source (not indicated in FIG. 1-1). In this embodiment, the capacitor C44 is a 10 μF capacitor that can tolerate up to 250V, although the capacitance of the capacitor C44 will vary from embodiment to embodiment, depending on the number of LEDs in the lighting circuit 10 as well as other factors. The capacitor C44 may be separated from the other components, e.g., placed in a separate housing away from the printed circuit board on which the other components are mounted. The current into the AC input line 104 is phase-shifted due to the capacitor C44.

In this embodiment, there are four sets of LEDs 18, 20, 22, 24. Two sets of LEDs 18, 20 receive AC power of 0° phase near the voltage peaks of the AC input line. The other two sets of LEDs 22, 24 receive phase-shifted power from the phase-shifted AC input line 14. All sets of LEDs 18, 20, 22, 24 are connected to the shared neutral line 16. In the drawings, the first two sets of LEDs 18, 20 are shown in FIG. 1-1, while the second two sets of LEDs 22, 24 are shown in FIG. 1-2.

Ideally, the phase-shift between the sets of LED light engines 18, 20 that are connected to the AC input line 12 and the sets of LED light engines 22, 24 that are connected to the phase-shifted AC input line 14 is 90°, although in practice, the phase difference between the two may be in the range of about 80-90°. Much of the remainder of this description refers to the ideal phase shift, recognizing that the phase shift in practice may be somewhat different. When used to describe periods, phases, phase shifts, and timings, the term “about” refers to this kind of deviation from ideal.

Generally speaking, the sets of LED light engines 18, 20, 22, 24 may be of any type, although much of this description assumes, for reasons that will be described below in more detail, that all of the sets of LEDs 18, 20, 22, 24 have LEDs that are of the same type. Although the sets of LED light engines 18, 20, 22, 24 are shown symbolically in FIG. 1 as having simple LEDs D1-D32h, the term “LED light engine” is used here to mean an LED or LEDs that are packaged along with all elements and connections necessary to produce light of a desired type. For example, the LEDs may be in an industry-standard 2216 package.

While the LED light engines may emit any type of light, this description will generally assume that the LEDs are of the “blue pump” type, in which one or more blue-light-emitting LEDs are packaged along with a phosphor, a chemical compound or mixture of chemical compounds that absorbs the blue light and re-emits light of a different color or broader spectrum of colors. The phosphor may top the package, covering the surface along which blue light would otherwise be emitted, and may be encapsulated within, e.g., a silicone adhesive/encapsulant. In this way, blue-pump LEDs are made to emit so-called “white” light.

Each LED light engine D1-D32h has a forward voltage. As those of skill in the art will appreciate, the forward voltage is a threshold voltage that must be met or exceeded for current to flow through the LED light engine D1-D32h, and thus, for the LED light engine D1-D32h to emit light. FIG. 1 and the following description will assume that in the lighting circuit 10, each LED light engine D1-D32h has a forward voltage of 18V. As an individual blue-emitting LED has a forward voltage of about 3V; this implies that the LED light engines D1-D32h each have 6 individual LEDs within the light engine package. However, the number of LEDs in any single LED light engine and the forward voltage of each LED light engine may vary from embodiment to embodiment.

The lighting circuit 10 is constructed and adapted such that each of the four sets of LED light engines 18, 20, 22, 24 emits light during a different portion of a single phase-cycle. That is, the lighting circuit 10 divides a single phase-cycle into four parts and illuminates the LEDs D1-D32h of one of the sets of LED light engines 18, 20, 22, 24 during each of the portions of the phase cycle.

As was noted above, two of the sets of LED light engines 18, 20 receive the AC power at 0° phase, and two of the sets of LED light engines 22, 24 receive AC power with about a 90° phase-shift. Additionally, diodes D16, D17, D18, D19 are used to control whether a set of LED light engines 18, 20, 22, 24 activates during the positive half-cycle or the negative half-cycle.

As shown in FIG. 1-1, a first set of LED light engines 18 is connected to the AC input line 12 through diode D16. Diode D16 is, for example, a diode with a small forward voltage (e.g., 1V), a large reverse voltage (e.g., 700V) and the ability to handle the current that is expected to be drawn through it (e.g., 1A). As one example, a 1N4007G diode may be used. Diode D16 is arranged in the circuit to be forward-biased by the voltage of the positive half-cycle from the AC input line 12. That is, the anode of diode D16 is connected to the AC input line 12, and its cathode is connected to the LED light engines D1-D11h. The anodes of the LED light engines D1-D11h are arranged such that they point toward the cathode of diode D16.

As is also shown in FIG. 1-1, a second set of LED light engines 20 is connected to AC input line 12 through diode D17. Diode D17, which may be of the same type and have the same specifications as diode D16, is arranged such that it is forward-biased by the voltage of the negative half-cycle from the AC input line 12. That is, the cathode of diode D17 is connected to the AC input line 12, and its anode is connected to the LED light engines D2-D12h. More specifically, the cathodes of the LED light engines D2-D12h are arranged such that they point toward the anode of diode D17.

Thus, the first set of LED light engines 18 is active during the positive half-cycle, while the AC voltage is greater than the forward voltage of the LEDs. Typically, this amounts to about the middle half of the positive half-cycle. Similarly, the second set of LED light engines 18 is active during the negative half-cycle, when the AC voltage is sufficient, amounting to the middle half of the negative half-cycle.

As shown in FIG. 1-2, a third set of LED light engines 22 is connected to the phase-shifted AC input line 14 through a diode D18 which may be of the same type and the same characteristics as the diodes D16, D17 described above. Diode D18 is arranged in the circuit to be forward-biased by the voltage of the positive half-cycle from the phase-shifted AC input line 14. This occurs as the unshifted AC voltage varies from the negative peak to the positive peak. The anode of diode D18 is connected to the phase-shifted AC input line 14, and its cathode is connected to the LED light engines D21-D31h. The anodes of the LED light engines D21-D31h are arranged such that they point toward the cathode of diode D18.

As shown in FIG. 1-2, a fourth set of LED light engines 24 is connected to the phase-shifted AC input line 14 through a diode D19 which may be of the same type and the same characteristics as the diodes D16, D17, D18 described above. Diode D19 is arranged such that it is forward-biased by the voltage of the negative half-cycle from the phase-shifted AC input line 14. That is, the cathode of diode D19 is connected to the phase-shifted AC input line 14, and its anode is connected to the LED light engines D22-D32h. The cathodes of the LED light engines D22-D32h are arranged such that they point toward to the anode of diode D19.

The first and second sets of LED light engines 18, 20, which are connected to the AC input line 12, are arranged differently than the third and fourth sets of LED light engines 22, 24, which are connected to the phase-shifted AC input line 14. More particularly, the first set of LED light engines 18 comprises nine individual sets 26 of six cathode-to-anode, series-connected LED light engines. Each of the individual sets 26 also has three resistors connected in series with the other components. Thus, for example, one individual set has, in series, LED D1, LED D3, resistor R1, LED D5, LED D7, resistor R3, LED D9, LED D11, and resistor R5. Each of the resistors R1, R3, R5 in this embodiment is a 1069Ω resistor. As those of skill in the art will appreciate, a single resistor of larger resistance could be substituted for the three resistors R1, R3, R5 in each individual set 26, but using three separate resistors R1, R3, R5 spaced from one another diffuses heat more efficiently and avoids “hot spots” on the printed circuit board.

The second set of LED light engines 20 is arranged similarly to the first set of LED light engines 18, with nine individual sets 28 of LED light engines arranged electrically in parallel with one another between diode D17 and the shared neutral line 16. The arrangement of diodes and resistors in the individual sets 28 is roughly the same as in the first set of LED light engines 18, except that, as described briefly above, the anode of diode D17 points to the cathode of each of the LEDs. One individual set 28 contains, in series, with diodes connected anode-to-cathode, LED D2, LED D4, resistor R2, LED D6, LED D8, resistor R4, LED D10, LED D12, and resistor R6. The resistors R2, R4, R6 in the individual sets 28 have the same resistance as the resistors R1, R3, R5 in this embodiment.

In the first and second sets of LED light engines 18, 20, because the LED light engines D1-D12h in the individual sets 26, 28 are in series, their collective (i.e., additive) forward voltage determines when they will light. The collective forward voltage of six LEDs, each with a forward voltage of 18V, is 108V. This relatively large forward voltage (as compared with the peak voltage of the AC power cycle) ensures that each one of the sets of LED light engines 18, 20 is active and emitting light for about one-quarter of the AC power cycle.

As those of skill in the art will note, although the first and second sets of LED light engines 18, 20 are configured somewhat differently so that they emit light in different half-cycles, in this embodiment, the components (i.e., resistors, LEDs, diodes) are the same regardless of the set of LED light engines 18, 20. As will be described below in more detail, much the same is true of the third and fourth sets of LED light engines 22, 24.

More broadly, while the sets of LED light engines 18, 20, 22, 24 are configured somewhat differently from one another so that they light at different points in the power cycle, they are all configured so that when a set of LED light engines 18, 20, 22, 24 is lit, each LED light engine is receiving the same, or about the same, amount of current. Because the luminous flux (i.e., the emitted light) of an LED is proportional to the current that flows through it, this means that when a set of LED light engines 18, 20, 22, 24 is emitting light, it emits the same amount of light as any of the other sets of LED light engines 18, 20, 22, 24 when they are emitting light. Put another way, it is preferable for the lighting circuit 10 to produce a constant, or very nearly constant, luminous flux throughout an AC phase-cycle, regardless of which set of LED light engines 18, 20, 22, 24 is lit, so as to reduce visible flicker.

In the third and fourth sets of LED light engines 22, 24, the LED light engines and resistors are arranged differently. In the third set of LED light engines, there are 54 LED light engines D21-D31h, each one arranged electrically in parallel with the others between diode D18 and the shared neutral line 16. Each of anodes of the LED light engines D21-D31h is connected to the cathode of diode D18, and each LED light engine D21-D31h is connected in series with a single resistor R21-R31h. In contrast to the resistors R1-R6 described above, the resistors R21-R31h all have very small resistances, in this embodiment, 100Ω per resistor. The resistors R21-R31h prevent current hogging when LEDs are in parallel due to differences in forward voltage drop of the LEDs.

The fourth set of LED light engines 24 is constructed similarly to the third set of LED light engines 22. Specifically, 54 individual LED light engines D22-D32h are arranged in parallel with one another between diode D19 and the shared neutral line 16. Each of the cathodes of LED light engines D22-D32h is connected to the anode of diode D19, and each LED light engine D22-D32h is connected in series with a single resistor R22-R32h. Like the resistors R21-R31h, the resistors R22-R32h each have a very small resistance in this embodiment, 100Ω per resistor.

The third and fourth sets of LED light engines 22, 24 have LED light engines D21-D32h arranged in parallel so as to keep the phase-shift of those LED light engines D21-D32h as close to 90° as possible. In this configuration, the voltage across each of D21-D32h is small with respect to the voltage across the capacitor C44. More particularly, if the individual forward voltage of one of the LED light engines D21-D32h is 18V, this means that the third and fourth sets of LED light engines 22, 24 will light as soon as the AC voltage reaches ±18V. However, if multiple LED light engines were arranged in series, the forward voltage would be additive, and the greater the forward voltage, the later in the AC power cycle the third and fourth sets of LED light engines 22, 24 will light.

In general, in the sets of LED light engines 18, 20 that receive unshifted power, the current is in phase with the voltage. Thus, these two sets of LED light engines 18, 20 light around the peaks of the voltage waveform. By contrast, the sets of LED light engines 22, 24 that receive current through the capacitor C44 light around the zero-crossings of the voltage waveform, where the current in the capacitor is at a maximum.

FIG. 2 is a graph, generally indicated at 100, in which the voltage-time waveform of the input power 102 is superimposed on the current-time waveforms for the 0°-phase sets of LEDs 106 and the phase-shifted LEDs 104. In graph 100, when either current waveform 104, 106 is nonzero, some set of LED light engines 18, 20, 22, 24 is illuminated. As can be appreciated from graph 100, the peaks and troughs of the current waveforms 104, 106 are slightly shifted with respect to the peaks and troughs of the input power waveform 102. However, together, the two waveforms 104, 106 cover substantially all of a power cycle, i.e., at almost any point in the power cycle illustrated by the input power waveform 102, some set of LED light engines 18, 20, 22, 24 is emitting light. First to illuminate, after the positive zero crossing of FIG. 2, is the third set of LED light engines 22, as shown by the portion of waveform 104 indicated at 108. As the current, and thus, the luminous flux, begins to decline in the third set of LED light engines 22, the 0° phase first set of LED light engines 18 begins to emit light, as shown by the portion of waveform 106 indicated at 110. The rise and fall of current in the first set of LED light engines 18, shown at 110 in FIG. 2, overlaps the rise and fall of current in the phase-shifted third set of LED light engines 22, shown at 110 in FIG. 2. Together, as shown at 108 and 110 in FIG. 2, the first and third sets of LED light engines 18, 22 cover almost the entire time of the positive half-cycle of the input power waveform 102.

As the current and resulting luminous flux decline in the first set of LED light engines 18, the voltage of the input power waveform 102 declines toward its negative peak, and current flows in the fourth set of LED light engines 24, as indicated at 112 in FIG. 2. Similar to the positive half-cycle, as current in the fourth set of LED light engines 24 begins to return to zero, current flows within the second set of LED light engines 20, as shown at 114 in FIG. 2 and the second set of LED light engines 20 illuminates. The rise and fall of current in the fourth set of LED light engines 24, shown at 112 in FIG. 2, overlaps the rise and fall of current in the 0°-phase second set of LED light engines 20, shown at 114 in FIG. 2. Together, as shown at 112 and 114 in FIG. 2, the second and fourth sets of LED light engines 20, 22 cover almost the entire time of the negative half-cycle of the input power waveform 102.

In an ideal circuit, the current in one set of LED light engines 18, 20 declines at the same time and at the same rate that the current in a counterpart phase-shifted set of LED light engines 22, 24 is rising, so that there is always the same, or about the same, net amount of luminous flux from the sets of LED light engines 18, 20, 22, 24. However, the ideal is not always necessary. As those of skill in the art will appreciate from FIG. 2, the current waveforms 104, 106 do not peak at precisely the same current, and do not form perfect sinusoids. There are also “shoulders” in the current waveforms 104, 106, e.g., periods of time 116 and 118, where current is not flowing in any set of LED light engines, and therefore, there is no emitted light. These periods of time 116, 118 are short compared to the duration of a power cycle, representing flicker-frequencies of about 240 Hz. However, the shoulder is so narrow that when a 200 Hz low pass filter is applied in evaluating flicker, it results in only a very small variation in average flux.

This kind of variation is permissible in the lighting circuit 10 because the objective is to reduce visible flicker, and the human eye does not perceive or respond to frequencies above about 200 Hz. However, although much of this description focuses on reducing visible flicker, which is typically defined as being frequencies below 200 Hz, it may also be useful to consider stroboscopic effects up to 2000 Hz. Ultimately, the range of flicker frequencies one considers will depend on the application for which the lighting circuit 10, or a luminaire including it, is intended.

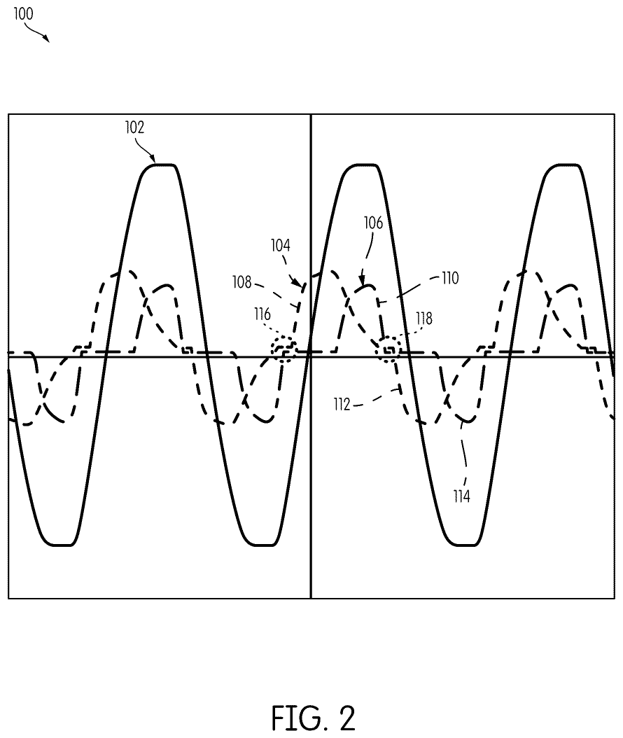

Beyond the features of the lighting circuit 10 described above, embodiments of the invention may physically arrange the sets of LED light engines 18, 20, 22, 24 in ways that reduce visible flicker. FIG. 3 is a top plan view of a strip of LED linear lighting, generally indicated at 300, according to an embodiment of the invention. As those of skill will appreciate, many forms of LED lighting may be used with a lighting circuit like lighting circuit 10; linear lighting 300 is one example. The linear lighting 300 has a long, relatively narrow printed circuit board (PCB) 302. The PCB 302 may be flexible or rigid. If the PCB 302 is rigid, it may be made, e.g., from FR4 composite, ceramic, etc. Flexible PCB 302 may be made, e.g., from biaxially-oriented polyethylene terephthalate (BoPET; MYLAR®) or polyimide (KAPTON®) films.

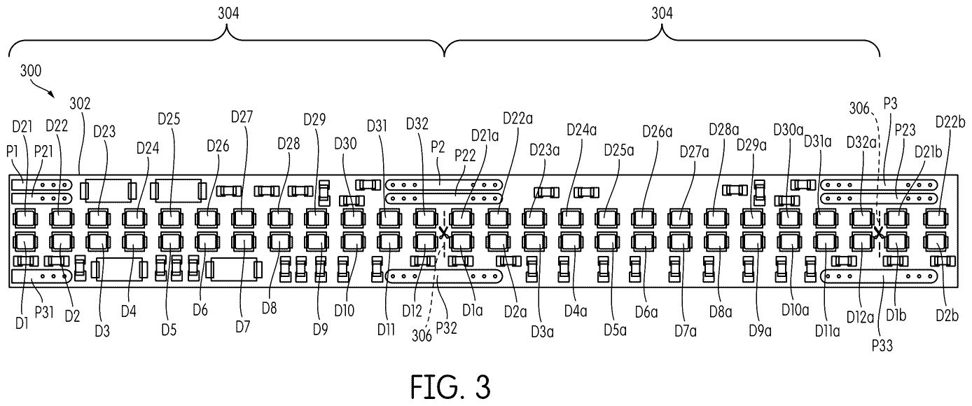

The PCB 302 may have a two-layer structure, a lower layer having electrical conductors, and a top layer, on which components are surface-mounted. Other embodiments may use through-hole mounting and or other types of mounting and may have more or fewer layers. Of course, FIG. 4 illustrates only a small portion of the full lighting circuit 10.

The PCB 302 is divided into repeating blocks 304. A “repeating block” 304 is a complete lighting circuit that will light if powered. Two repeating blocks 304 and a portion of a third repeating block 304 are shown in FIG. 3. Cut points 306 indicate the physical locations on the PCB 302 where one repeating block 304 ends and the next repeating block 304 begins. The cut points 306 may be physically indicated on the PCB 302 with screen-printed indicia, as is the case in FIG. 3, or they may be deduced from landmarks on the PCB 302. For example, a repeating block 304 typically terminates at contact pads P2, P22, P32.

The PCB 302 can be cut at the cut points 306 to cut it to a desired length. In high voltage applications, by which this description means voltages over 50V, this would typically be done in the factory or by a trained, authorized service center. In low voltage applications, which pose less of a safety risk, the PCB 302 may be cut by the installer or end-user.

In a practical embodiment, the entire lighting circuit 10 and its 216 LED light engines D1-D32h may be placed on a PCB that is, e.g., 11.5 mm (0.45 in) wide and 399.6 mm (15.7 in) long. The PCB 302 may be divided into repeating blocks 304, each of which is 44.4 mm (1.73 in) long. If longer runs of light are needed, multiple PCBs 302 may be placed adjacent to one another or, in some cases, physically connected at overlapping joints. (Overlapping-joint connection, which usually connects two adjacent PCBs both mechanically and electrically, is most often used with flexible PCB.) Of course, varying the length of the PCB 302 may require changing the value of capacitor C44.

While the LED light engines D1-D32h appear to be arranged in two long rows on the PCB 302, electrically, the LED light engines D1-D32h are arranged in 2×2 clusters, with one LED light engine D1-D32h from each set of LED light engines 18, 20, 22, 24 in each cluster.

FIGS. 4-7 are simplified top-plan views of the PCB 302, illustrating one cluster 350 containing four LED light engines D1, D2, D21, D22. As can be seen in FIGS. 1-1 and 1-2, LED light engine D1 is a part of the first set of LED light engines 18, LED light engine D2 is part of the second set of LED light engines 20, LED light engine D21 is part of the third set of LED light engines 22, and LED light engine D22 is part of the fourth set of LED light engines 24. FIGS. 4-7 are in chronological order, showing the activation sequence of the LED light engines D1, D2, D21, D22 during the single AC power cycle.

As shown in FIG. 4, LED light engine D1 lights first, in the lower left-hand corner of the cluster 350 covering about a quarter of a power cycle centered at the positive peak of the voltage. Then, as shown in FIG. 5, LED light engine D22, in the upper right-hand corner of the cluster 350 lights next, covering a quarter of a power cycle centered on the negative-going zero crossing of the voltage. Following that, as shown in FIG. 6, LED light engine D2, in the lower right corner of the cluster 350, lights next, covering the portion of the power cycle centered on the negative voltage peak. Finally, as shown in FIG. 7, LED light engine D21, in the upper right corner of the cluster 350, lights, covering the positive-going zero crossing of the voltage. This pattern repeats with every power cycle.

The pattern described above and shown in FIGS. 4-7 has a particular advantage: it is unlikely to create the impression of motion in the viewer. By contrast, if the LED light engines D1, D2, D21, D22 were arranged in a cluster 350 such that they lit in a clockwise pattern, a counterclockwise pattern, or a linear pattern, the viewer might discern a pattern of motion. In most embodiments, the objective is to produce the appearance of unflickering, static light emission; thus, patterns of motion are undesirable. With the pattern shown in FIGS. 4-7, because of human persistence of vision, the viewer will see only static illumination. In picking an illumination pattern such as that shown in FIGS. 4-7, the collective appearance of the LED light engines D1-D32h in adjacent clusters 350 should also be considered so as to avoid a “wavelike” pattern in which light appears to move up and down a strip of LED linear lighting 300. As those of skill in the art will note, the chosen pattern may vary with the physical form and arrangement of the LED luminaire.

As may be apparent from the above, one aspect of the invention may be embodied in a method. The method may comprise providing a cluster of LED light engines on a PCB, with the LED light engines in the cluster being physically adjacent to one another; dividing an AC power cycle into a plurality of portions; and illuminating at least one LED from the cluster during each of the portions of the AC power cycle. The illumination of the LED light engines is performed such that the cluster has a substantially constant luminous flux throughout the AC power cycle. The term “substantially constant” here means that variations in the luminous flux do not result in perceptible flicker. Practically, this means that variations in luminous flux generally occur at a frequency higher than can be perceived by the human eye, e.g., above 200 Hz. As an example, a lighting circuit 10 that produces the kind of current-time output shown in FIG. 2 can be considered to produce a “substantially constant” luminous flux for purposes of this description. In other terms, a lighting circuit 10 according to an embodiment of the invention may have less than 30% flicker, less than 20% flicker, less than 10% flicker, about 5% flicker, etc. A definition of flicker will be given below.

Many variations on the embodiment described above are possible. For example, in the above, a capacitor C44 is used to induce a phase shift. In other embodiments, a different type of phase-shifting component may be used. A phase shift may be induced by any component that has an electrical reactance, whether that reactance is inductive or capacitive in nature. In many embodiments, the use of a capacitor may be preferable to the use of an inductor, because of the larger size of and cost of inductors relative to capacitors. However, particularly if the LED luminaire has a larger or different form, an inductor may be useful. A lighting circuit using an inductor instead of capacitor C44 would have the same basic topology as the lighting circuit 10 shown above. A 0.7H inductor would likely be sufficient as a substitute for capacitor C44.

The lighting circuit 10 described above uses LED light engines 18, 20, 22, 24 arranged to illuminate during four different portions of an AC power cycle. If the objective is to give the lighting circuit 10 a basic frequency above a flicker threshold of 200 Hz and the input AC power is at 60 Hz, using the four sets of LED light engines arranged as described above gives the lighting circuit 10 a basic frequency of 240 Hz. That said, a larger number of phases could be used. For example, a lighting circuit according to embodiments of the invention could use six or eight sets of LED light engines, each one having a different phase. As those of skill in the art will understand, additional phases can be created, e.g., by using two or three reactive components, each with a different reactance, and by including additional LED light engines in series with one another in the phase-shifted sets of LED light engines so as to alter the phase of those sets of LED light engines relative to the 0°-phase sets of LED light engines. Ultimately, a plurality of sets of LED light engines could be used, some of those sets configured and adapted to receive phase-shifted AC power.

As more sets of LED light engines are used, difficulty may arise in placing the individual LED light engines in closely-spaced clusters, such that each cluster appears to emit light continuously through the AC power cycle. Thus, with large clusters, it may be helpful to diffuse the light, to make any potentially perceptible variations in emission less apparent. A wide variety of diffusing technologies are known in the art and may be used, if needed, for this purpose. As one example, the kind of diffusing cover disclosed in U.S. Pat. No. 11,199,300, the contents of which are incorporated by reference herein, may be used.

As those of skill in the art will recognize, the lighting circuit 10 described above uses analog electronics to drive the LED light engines. Among other advantages, analog electronics are simple and inexpensive. However, a digital LED controller could be used to divide the AC power cycle into multiple portions and to activate different LED light engines during different portions of the AC power cycle.

### Example

The lighting circuit 10 of FIGS. 1-1 and 1-2 was constructed and a pin photodiode with a response time of 4 ns was positioned to observe the light output (i.e., luminous flux) from the lighting circuit 10. The pin photodiode was positioned at about 3 inches (7.6 cm) above the lighting circuit, a distance sufficient to observe the light output of the lighting circuit 10 in the aggregate. As described above, the constructed lighting circuit 10 was powered with U.S.-standard 60 Hz, 120 VAC power.

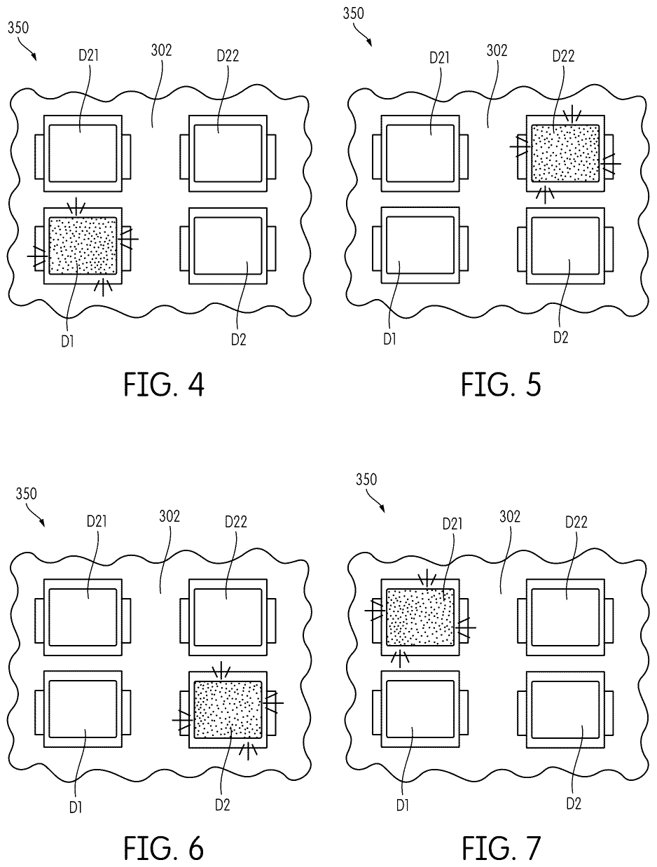

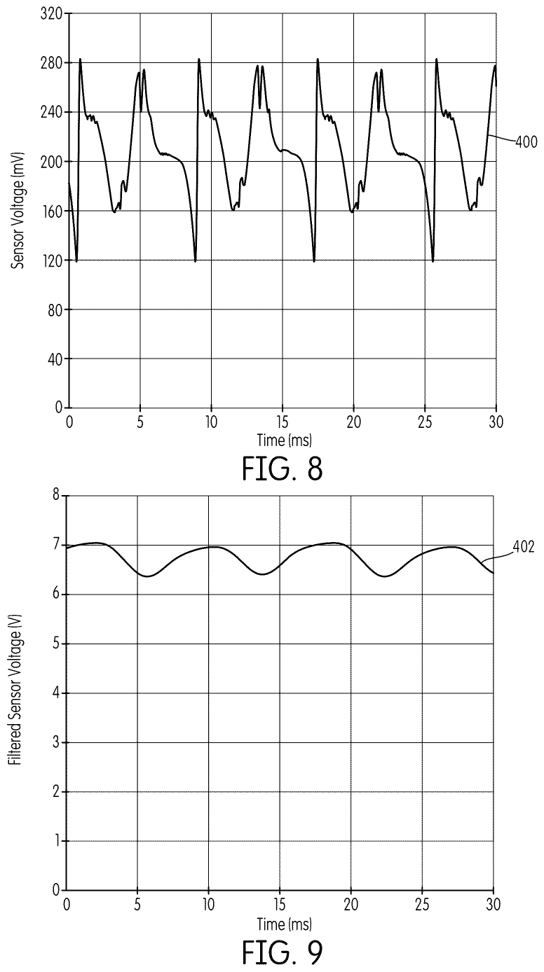

FIG. 8 is a plot of the voltage output of the photodiode over time. In FIG. 8, the X-axis is in milliseconds (ms) and the Y-axis displays the voltage output of the photodiode in millivolts (mV). The voltage output is generally indicated at 400 in FIG. 8. FIG. 9 is a similar plot showing the voltage output 400 filtered through a brick-wall low-pass filter to eliminate harmonics over 200 Hz and amplified. This filtered, amplified waveform 402 is generally sinusoidal with a maximum of 7.062V and a minimum of 6.373V. At the time of writing, California Title 24 regulations define percent flicker as in Equation (1) below:

$$F = \frac{( Max Output - Min Output )}{( Max Output + Min Output )} \times 100 \% \qquad ( 1 )$$

By that definition, flicker for the lighting circuit 10 is calculated according to Equation (2) below:

$$F = \frac{7.062 - 6.373}{7.062 + 6.373} \times 100 \% = 5.1 \% \qquad ( 2 )$$

The measured flicker of 5.1% is well below the 30% limit applied by the Title 24 regulations at the time of writing.

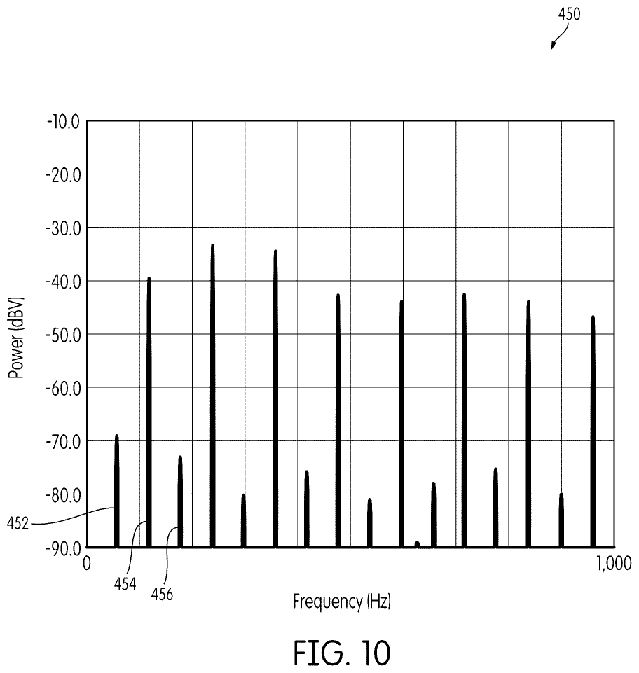

FIG. 10 is a power (Fourier) spectrum, generally indicated at 450, taken of the unfiltered voltage output 400 of FIG. 8. The power spectrum 450 is taken in the range of 0-1000 Hz, and the amplitude of FIG. 8 was adjusted so that the total power is 0 dBV. Notably, there are spectral lines at 60 Hz, 120 Hz, and 180 Hz. However, the amplitude of each of these is small. The 60 Hz spectral line, indicated at 452, is-60 dB or 0.1% of the total energy, which is negligible. The 120 Hz spectral line, indicated at 454, is −30 dB or 3% of the total energy. The 180 Hz line, indicated at 456, is-62 dB or 0.08% of the total energy. Because flicker is defined relative to the human visual frequency-response limit of 200 Hz, while there are harmonics above 200 Hz, these are essentially irrelevant to conventional flicker.

This description uses the term “about.” When that term is used in association with a numerical range or time period, it means that the range or period in question may vary so long as the described result stays materially the same. If the degree of permissible variation cannot be discerned for a particular range or period, the term about should be construed to mean ±10%.

While the invention has been described with respect to certain embodiments, the description is intended to be exemplary, rather than limiting. Modifications and changes may be made within the scope of the invention, which is defined by the appended claims.

What is claimed is:

1. A lighting circuit, comprising:
a printed circuit board (PCB);
a plurality of sets of LED light engines disposed on the PCB, each of the plurality of sets of LED light engines configured to receive AC power and to emit light during a different portion of a single AC power cycle;
wherein some of the plurality of sets of LED light engines receive phase-shifted AC power; and
wherein the different portions are coordinated such that the lighting circuit has a substantially constant luminous flux throughout the single AC power cycle.

2. The lighting circuit of claim 1, further comprising a phase-shifting component having an electrical reactance, the phase-shifting component changing a phase of the current of the AC power relative to the voltage of the AC power to create the phase-shifted AC power.

3. The lighting circuit of claim 2, wherein the phase-shifting component comprises a capacitor.

4. The lighting circuit of claim 2, wherein the phase-shifting component comprises an inductor.

5. The lighting circuit of claim 2, wherein the plurality of sets of LED light engines further comprise:
a first set of LED light engines configured to receive the AC power and to be forward-biased during a positive half-cycle of the AC power cycle;
a second set of LED light engines configured to receive the AC power and to be forward-biased during a negative half-cycle of the AC power cycle;
a third set of LED light engines configured to receive the phase-shifted AC power and to be forward-biased during a positive half-cycle of the AC power cycle; and
a fourth set of LED light engines configured to receive the phase-shifted AC power and to be forward-biased during a negative half-cycle of the AC power cycle.

6. The lighting circuit of claim 5, wherein
LED light engines of the first set of LED light engines, the second set of LED light engines, the third set of LED light engines, and the fourth set of LED light engines are arranged on the PCB in clusters, with one of the LED light engines of each of the first set of LED light engines, the second set of LED light engines, the third set of LED light engines, and the fourth set of LED light engines in each of the clusters.

7. The lighting circuit of claim 6, wherein each of the clusters is arranged such that sequential lighting of the LED light engines in each cluster will not create an illusion of movement.

8. The lighting circuit of claim 5, wherein each of the LED light engines of the third set of LED light engines is arranged electrically in parallel with others of the third set of LED light engines, and each of the LED light engines of the fourth set of LED light engines is arranged electrically in parallel with others of the fourth set of LED light engines.

9. The lighting circuit of claim 1, wherein the lighting circuit is implemented as a strip of LED linear lighting.

10. A lighting circuit, comprising:
at least one phase-shifting component having an electrical reactance;
a printed circuit board (PCB);
an AC power input line on the printed circuit board, the AC power input line configured to receive AC power;
a phase-shifted AC power input line configured to receive phase-shifted AC power from the at least one phase-shifting component;
a neural line;
a first set of LED light engines disposed on the PCB and connected to the AC power input line and the neutral line;
a second set of LED light engines disposed on the PCB and connected to the AC power input line and the neutral line;
a third set of LED light engines disposed on the PCB and connected to the phase-shifted AC power input line and the neutral line;
a fourth set of LED light engines disposed on the PCB and connected to the phase-shifted AC power input line and the neutral line;
a first diode connected between the AC power input line and the first set of LED light engines, the first diode and the first set of LED light engines arranged such that the first set of LED light engines is forward-biased during a positive half-cycle of the AC power;
a second diode connected between the AC power input line and the second set of LED light engines, the second diode and the second set of LED light engines arranged such that the second set of LED light engines is forward-biased during a negative half-cycle of the AC power;
a third diode connected between the phase-shifted AC power input line and the third set of LED light engines, the third diode and the third set of LED light engines arranged such that the third set of LED light engines is forward-biased during a positive half-cycle of the phase-shifted AC power; and
a fourth diode connected between the phase-shifted AC power input line and the fourth set of LED light engines, the fourth diode and the fourth set of LED light engines arranged such that the fourth set of LED light engines is forward-biased during a negative half-cycle of the phase-shifted AC power.

11. The lighting circuit of claim 10, wherein the at least one phase-shifting component creates a phase shift of about 80-90°.

12. The lighting circuit of claim 10, wherein the at least one phase-shifting component comprises a capacitor.

13. The lighting circuit of claim 10, wherein the at least one phase-shifting component comprises an inductor.

14. The lighting circuit of claim 10, wherein
LED light engines of the first set of LED light engines, the second set of LED light engines, the third set of LED light engines, and the fourth set of LED light engines are arranged on the PCB in clusters, with one of the LED light engines of each of the first set of LED light engines, the second set of LED light engines, the third set of LED light engines, and the fourth set of LED light engines in each of the clusters.

15. The lighting circuit of claim 14, wherein each of the clusters are arranged such that lighting of the LED light engines in each cluster will not create an illusion of movement.

16. The lighting circuit of claim 10, wherein the lighting circuit is implemented as a strip of LED linear lighting.

17. A lighting circuit, comprising:
a printed circuit board (PCB);
a cluster of LED light engines provided on the PCB; and
a drive circuit adapted to receive AC power, to divide an AC power cycle of the AC power into multiple portions, and to cause at least one of the LED light engines in the cluster to illuminate during each of the multiple portions of the AC power cycle;
wherein the drive circuit maintains a substantially constant luminous flux for the cluster throughout the AC power cycle.

18. The lighting circuit of claim 17, wherein the drive circuit receives phase-shifted AC power and provides to the phase-shifted AC power to at least some of the LED light engines.

19. The lighting circuit of claim 17, wherein the lighting circuit has flicker of less than 30%.

20. A method, comprising:
providing a cluster of LED light engines on a PCB, with the LED light engines in the cluster being physically adjacent to one another,
dividing an AC power cycle into a plurality of portions; and
illuminating at least one LED light engine from the cluster during each of the portions of the AC power cycle;
wherein said illuminating is performed such that the cluster has a substantially constant luminous flux throughout the AC power cycle.
